(19) United States
(12) Patent Application Publication
(10) Pub. No.: US 2012/0031023 A1
(43) Pub. Date: Feb. 9, 2012

(54) FRAME CONSTRUCTION FOR A FENESTRATION

(75) Inventors: Richard Scalzi, Sharon, MA (US); Steve Kelley, Sharon, MA (US)

(73) Assignee: Specialty Casings Company, Stoughton, MA (US)

(21) Appl. No.: 12/987,545

(22) Filed: Jan. 10, 2011

Related U.S. Application Data
(63) Continuation-in-part of application No. 12/851,298, filed on Aug. 5, 2010.

(51) Int. Cl. E06B 1/26; E04C 2/38; E06B 1/04

(52) U.S. Cl. 52/211; 52/656.5

(57) ABSTRACT

A window frame assembly for a window opening in which the assembly comprises a casing facing that covers the casing with a J-channel secured to the casing facing and defining an outwardly facing channel to receive bordering edges of siding material, and a casing molding having one longitudinal edge continuous with the casing facing and a second longitudinal edge outwardly and non-planar with the one longitudinal edge and engaging the J-channel. The casing molding of a color contrasting with either or both of the J-channel and casing facing.

### RELATED APPLICATIONS

The present invention is a continuation-in-part of application Ser. No. 12/851,298, filed Aug. 5, 2010.

### BACKGROUND OF INVENTION

The present invention relates to trim and a trim assembly for framing windows, doors, or the like in a wall fenestration.

Modern building constructions, particularly of homes and residences, ordinarily provide wall fenestrations in the building wall which receive windows or the like. A variety of window constructions may be inserted in these fenestrations, including simple window panes framed by sashes or casement windows or doors. In these installations, it has been common to provide a trim system to provide a finished look about the window or door positioned in the opening. These trim assemblies function not only to provide an attractive finish, but also serve the dual function of providing means for interengaging siding or other covering materials which ordinarily are used to cover or finish the building walls. Since the advent of siding products (vinyl, aluminum, wood, brick, etc.), numerous arrangements for covering fenestration trim areas have been devised whereby areas adjacent to the openings are covered with metal, wood, vinyl, paint, etc.

Trade names for some of the products currently available are “Lineals” and “Crown Mouldings.” None of these systems provide the overall advantages of the present invention as will be understood from the specification set forth hereafter.

An example of a commercial trim member is a molding which rests atop the casing of an opening. It is a single piece utilized as a cap on otherwise flat vinyl casing coverage and is not universally applicable.

Another, a product sold as Certain Teed's Restoration Millwork, creates an exterior architectural product of polymer and vinyl that is comparable in appearance to trim for fenestration openings. This product is not universally adaptable for fenestrations and is not simply installed.

It is therefore an object of the present invention to provide a set of trim components or a trim kit which may be fabricated as extrusions from suitable material, such as vinyl plastic for use in framing a window, door or the like.

An object of the present invention is to provide a simple casing molding construction which permits the simple fabrication of a window trim system that frames a door or window with the frame providing a reinforcing member and also has a shadow box appearance.

A further object of the present invention is to provide trim components which may be fabricated as extrusions from suitable material such as vinyl plastic for subsequent use in on site framing a window, door or the like or for use in a pre-cut trim kit.

It is also an object of the present invention to provide an improved trim kit or system of one or more components for use in finishing a window or door casing in a manner that is attractive, easily installed, and adaptable to a wide range of sizes, shapes, and uses, including the adaptability of the unit using multiple components in various color combinations.

It is a still further object of the present invention to provide an inexpensive trim assembly kit which may be adapted for a wide range of building constructions for purposes of finishing fenestrations and window casings in a manner that is inexpensive, easy to install, attractive in appearance, and adapted for a wide range of designs, appearances and uses.

One more object of the present invention is to provide designs for extrusions which are adaptable for use as a replacement installation, or as a new construction.

A still further object of the present invention is to provide a single extrusion for use in a trim kit or assembly that is shaped to be readily snap-locked or fastened into position to form a finished trim assembly.

One further object of the present invention is to provide an extrusion suitable to be used as a component in a trim assembly having spaced edges with the spaced edges each having interlocking components for interengaging bordering components.

### SUMMARY OF INVENTION

In the present invention, useful for interior or exterior fenestrations, there is provided a system which includes a minimum number of trim components or members which may be readily formed of metal, wood, plastic components or other building material in a variety of shapes by extrusions or simple bending processes and cut to size or assembled on site. In one embodiment the trim assembly preferably comprises an arrangement of an elongated casing face, an elongated casing molding that is continuous with the casing face, and an elongated J-channel, with the J-channel, in turn, securing and supporting in fixed relation the various siding or other finishing materials used on the outside of the building construction. Such a construction is particularly suited for use as a retrofit in renovating an existing structure.

The three components, namely the casing face, casing molding and J-channel, may be selectively formed as two or three separate but interengangeable components to permit use of different color trim elements for visual contrasts as well as for selective use of molding designs to enhance shadow effects of outdoor light on the assembled unit.

A single composite extrusion of all three components is also contemplated in one embodiment. In such an embodiment, the single component is provided with an interlock at either one or both side edges adapted to engage an underlying component of the trim assembly. Such an arrangement is suitable as a stand alone or new system.

In another preferred embodiment, the casing molding is formed as an extruded member cut to selected lengths and with a cross-sectional configuration having opposing side edges formed with locking mechanisms adapted to engage other components underlying the casing molding. This configuration allows the snapping of the casing molding into position once the casing facing has been positioned, thus reducing the time required of the installer to arrange and secure the various components. The design also provides a seamless appearing design with no nail holes or other securing members visible.

Previously, efforts to provide trim for fenestrations have not been particularly aesthetically attractive and in many instances could not be efficiently installed and were not universally adaptable for most fenestrations. The architectural design of this invention is aesthetically attractive as it utilizes reverse curves and rounded contour lines to create shadows or shadow box appearances to achieve an architecturally pleasing appearance. Additionally the present invention avoids the need to field fabricate trim areas of fenestration since the extrusions of the present invention may be pre-fabricated and packaged for approximately 90% of all commercial applications. The feature reduces time typically required in the field for fabricating trim coverage around openings.

Each of the primary components, the casing face, the casing molding and the J-channel, may be extruded or otherwise formed of suitable material such as metal, vinyl, plastic or other material normally used in building constructions. The components may also be formed in length of sheets appropriately folded and bent to conform to the cross-sectional dimensions desired for the element. Extrusions, however, are preferred to folding and bending sheets of material for various fabrication reasons. The various components may be made in various selected shapes to interlock one with the other and to simultaneously provide a selection of various finishes and appearances. If desired, one or more of the components may be painted or otherwise color formed to provide a contrasting color component to one or more of the elements forming this trim.

Use of extrusions to form the casing molding, in particular, provides an additional advantage in substituting for what would ordinarily be fabricated of wood. The extruded casing molding is light weight, costs less to make, is more readily installed, and may be designed with interlocking features not available in solid casing molding constructions.

Another feature of the present invention in one embodiment provides components that may snap together and interlock in an effective manner without exterior or face nailing or alternative adhesive methods such as is typically required with conventional products. Additionally, the present invention employs the conventional siding J-channel products into the final product such that it appears more seamlessly yet performs its function as a pocket for the siding products of the installer's choice.

### BRIEF DESCRIPTION OF DRAWINGS

These and other objects and advantages of the present invention will be more clearly understood when considered in conjunction with the accompanying drawings in which:

FIG. 1 is a plan elevational view of a window assembly embodying the present invention;

FIG. 2 is a fragmentary, cross-sectional detail taken along the lines 2-2 of FIG. 1 for use with fenestration bordered with siding;

FIG. 3 is a cross-sectional detail of a modification of the preferred embodiment, also taken essentially along the line 2-2 of FIG. 1;

FIG. 4 is a cross-sectional detail of a modification of the preferred embodiment, also taken substantially along the line 2-2 of FIG. 2;

FIG. 5 is a fragmentary, perspective view of a segment of a window and trim assembly embodying the present invention;

FIG. 6a is a cross-sectional detail of a sill cover;

FIG. 6b is a top-plan view of the sill cover of FIG. 6a;

FIG. 7a is an end view of the end cap for the sill cover of FIG. 6a;

FIG. 7b is an edge view of the cap of FIG. 7a; and

FIG. 7c is a plan view of the right end cap for the end of the sill cover shown in FIG. 6a.

FIG. 8 is a fragmentary, cross-sectional view showing a modified form of a casing face installed in a window frame using a blind nailing technique;

FIG. 9 is a plan view of the casing face shown in FIG. 8;

FIG. 10 is a cross-sectional view of a modification of the casing face shown in FIG. 8;

FIG. 11 is a cross-sectional view of a casing molding;

FIG. 12 is a top plan view of the casing molding of FIG. 11;

FIG. 13 is a cross-sectional view of a casing face and casing molding combination used for what is characterized in the trade as “brick molding”;

FIG. 14 is a cross-sectional detail of a J-channel used with the casing molding of FIGS. 11 and 13; and

FIG. 15 is a plan view of the J-channel shown in FIG. 14.

FIG. 16 is a cross-sectional view of a further modification of the casing molding useful for a fenestration bordered by siding.

FIG. 17 is a fragmentary, perspective view of a segment of a window and a trim assembly embodying the present invention useful as a stand-alone unit;

FIG. 17a is a cross-sectional view of a slightly modified version of FIG. 17;

FIG. 18 is a cross-sectional elevational view of a further modification of the present invention designed specifically as a stand-alone colonial casing installation.

FIG. 19 is a cross-sectional view of the extrusion forming the casing molding shown in FIG. 17a;

FIG. 20 is a plan view of an extrusion forming the casing flashing of FIG. 19;

FIG. 21a is a cross-sectional view of an extrusion forming a casing molding adapter or fastening strip;

FIG. 22 is a plan view of the casing molding adapter of FIG. 21a;

FIG. 23 is a plan view taken along lines 23-23 of FIG. 21a;

FIG. 23a is an elevational view taken along lines 23a-23a of FIG. 21a;

FIG. 24a is a fragmentary plan view of a partial assembly showing a corner block;

FIG. 24b is an elevational view of a corner block forming a portion of the invention;

FIG. 24c is a plan view taken along lines 24c-24c of FIG. 24b;

FIG. 24d is a plan view taken along lines 24d-24d of FIG. 24b;

FIG. 25a is a cross-sectional elevation of a modification of the casing molding and related components suitable for a new brick and molding installation;

FIG. 25b is a cross-sectional elevation of a modified casing molding as shown in FIG. 25a;

FIG. 25c is an end view of a mounting clip shaped to hold the casing face onto the edge of a standard window;

FIG. 25d is a top plan view of the elements shown in FIG. 25b;

FIG. 25e is a top plan view of the molding clip shown in FIG. 25c;

FIG. 26 is another modification of the casing molding and J-channel designed for installation as a brick mold for retrofit or new siding;

FIG. 27 is a perspective view of a corner piece shaped to receive adjacent, orthogonally related ends of a casing molding in an assembled frame.

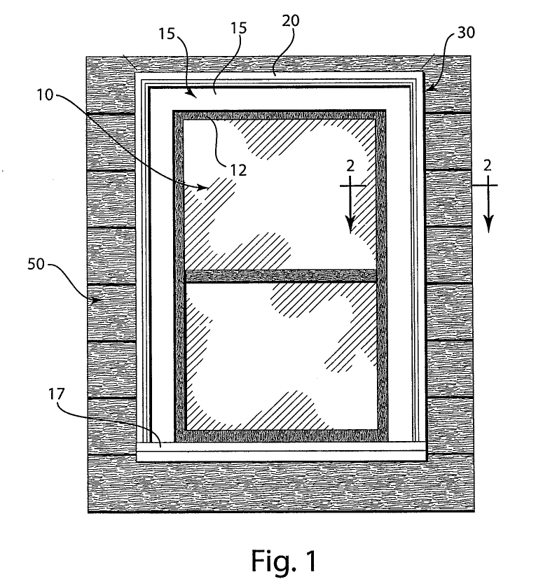

### DETAILED DESCRIPTION OF INVENTION

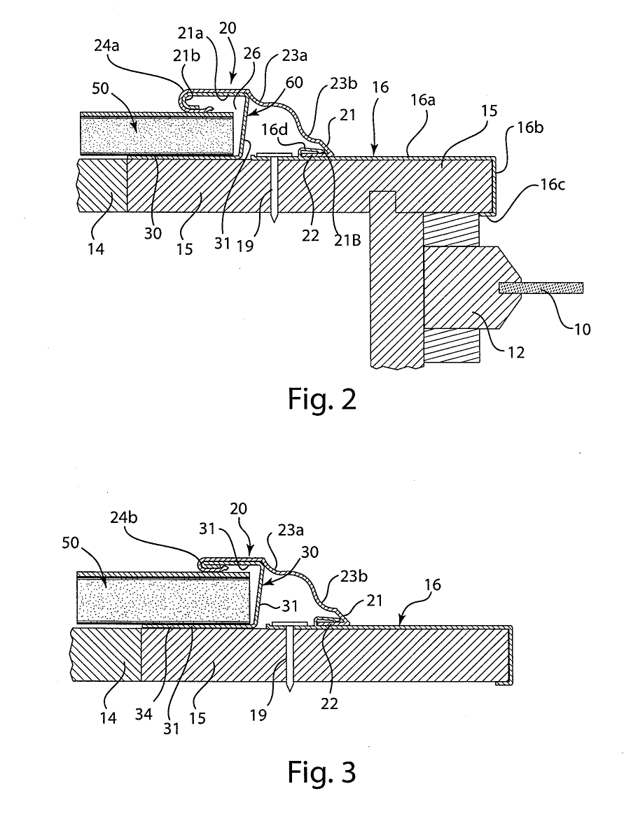

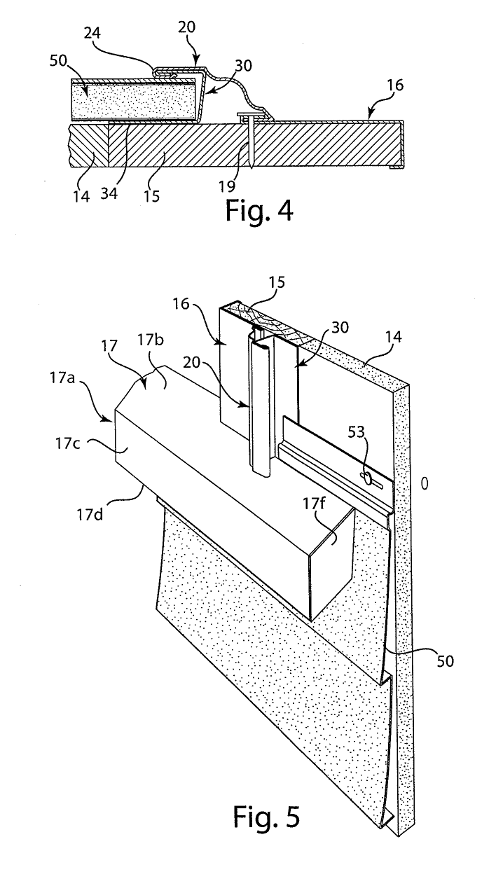

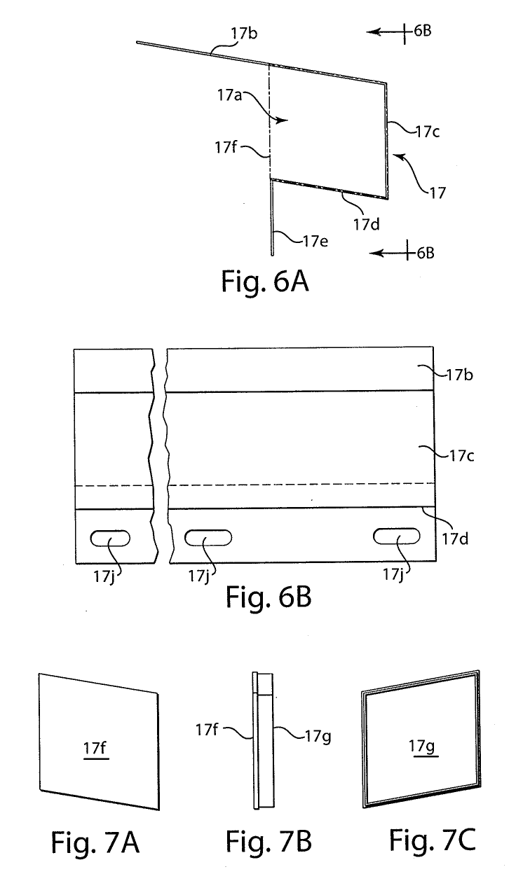

As noted, the present invention is directed primarily to a window, doors and other fenestrations treatment for installation in new or existing residential and commercial buildings, but has other applications. The designs are suitable for retrofits or new constructions. In the specific embodiments illustrated in FIGS. 2 and 3, there is shown an installed window trim assembly designed primarily as a retrofit for a residential building in which an interior or exterior building wall may be conventionally formed with a window opening or fenestration in which a window 10 is positioned. The window 10 may be a wide range of designs including simple designs in which the window pane is framed by a sash 12 or by other casement type windows. The window is secured to the building construction which may comprise a standard construction. For example, a wooden wall 14 (FIG. 2) supported by studs and framing (not shown) forms the shell of the building. The window opening is framed by a casing 15 which preferably extends about the sides and top of the opening and is finished by a sill suitably covered by a sill cover shown and further described in connection with FIGS. 6a through 7c. The window trim system comprises primarily a casing face 16, a casing molding 20 and a J-channel 30 interlocked and secured to the casing 15 as hereafter described. Finish siding material 50 (FIG. 5) positioned over the casing 15 is secured and fits into the J-shaped channel 30.

The casing face 16, as illustrated in FIGS. 2 and 3, may be formed by an elongated, metal, plastic or other sheet or extrusions providing a facing web 16a that lies against the outer surface of the casing 15. A flange 16b continuous with and positioned normal to web 16a lies in facing relation to the casing 15. At the remote end of the flange 16b is a lip 16c designed to engage and secure the facing web 16a in close relation to the casing 15. The facing web 16a extends along the surface of casing 15 and terminates in an integrally formed portion providing an apron-like segment having a series of holes through which the nails 19 may be secured to hold the casing face down in facing relation to the casing 15. The casing face 16 is also formed with a flange 22 parallel to the surface of the casing face 16 and defining a slot to receive one edge of the casing molding 20 as hereafter described.

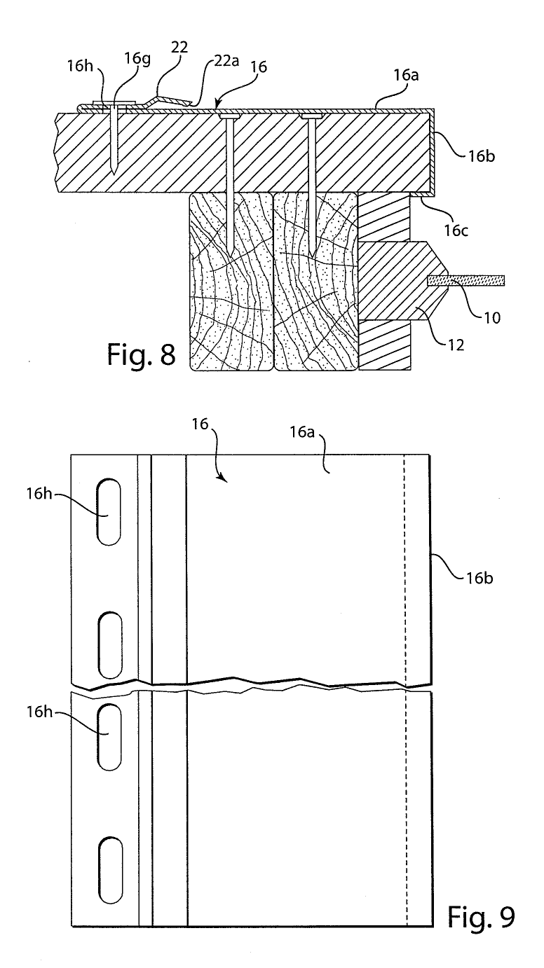

The casing molding 20 includes a web 21 positioned between outwardly extending flanges 21a and 21b and is integral therewith. Flange 21a and 21b are laterally spaced from one another with a non-planar web 21 extending angularly there between. Flange 21b is interengaged by the slot formed in the space between flange 22 and the surface of the facing 16 (see also FIG. 8). Flange 21a terminates in the loop 24 shaped to receive and engage in a locking position the one end of a J-channel 30 as hereafter described.

As illustrated in FIGS. 2 and 3, a J-shaped channel 30 having legs 31 lies flush against the inner surface of the casing molding to receive siding material 50. The J-shaped channel 30 has an end continuous with loop 24a conforming in shape and interengaged with loop 21a in an interlocking position. As illustrated in FIG. 2, the loop 24a and 24b may be open thus enabling the installer to readily interlock the loops 24a and 24b as shown in FIG. 3. The loop has been compressed and the assembly is essentially a permanent interlocked arrangement. The web 21 may vary in shape depending upon the decorative selections as desired. As illustrated, embodiments of FIGS. 2, 3 and 13, this web 21 is formed with reverse curves essentially creating two channels 23a and 23b. These channels may vary in width, depth and number. The design is selected to provide an attractive reflective surface for light impinging on the web and for enhancement of shadows created by sunlight. In place of the reverse curves, the invention also contemplates a zig-zag configuration designed to cause a shadow effect.

A modification of the embodiment of FIGS. 2 and 3 is illustrated in FIG. 8. In this arrangement, the casing face 16 is formed with the web portion 16a extending along the surface of the casing with like numbers essentially similar to those shown in FIGS. 2 and 3. In this arrangement, however, the casing face is formed with a slot 22a defined by a fold along one edge of a casing face 16. A nail 16g (FIG. 8) extends through the holes 16h formed in the casing face 16 to secure it to the casing.

Material for the casing face 16 may be formed of extruded lengths of plastic material or bent metal in varying lengths, as for example 20 feet long, which are then cut to size on site to the length of the sides and the upper end of the casing.

The window sill at the bottom of the window opening is similarly covered as illustrated in FIGS. 5-7c. In this arrangement, the sill cover 17 fits closely around a sill 17a (FIG. 6a). The sill cover includes an upper web 17b which extends close to the angled sill and terminates in a downwardly extending flange 17c which in turn is integral with the inwardly extending flange 17d, with the outwardly extending flange 17d terminating in a lip 17e that is secured to the wall 14 below the opening by conventional means. The sill cover 17 may be secured to the sill by means of nails secured to the sill through openings 17j (FIG. 6b). The ends of the sill cover 17 may be closed by end caps 17f and 17g shown in FIGS. 7a and 7c.

As illustrated in FIG. 5, the J-shaped channel 30 forms a recess at its inner end to receive shingling or siding material 50. The siding material may, as illustrated in FIG. 5, comprise shingles or sheets of vinyl or other plastics or composite construction material shaped to simulate a shingle effect. These sheets are secured by conventional means to the outer wall of the building construction 53.

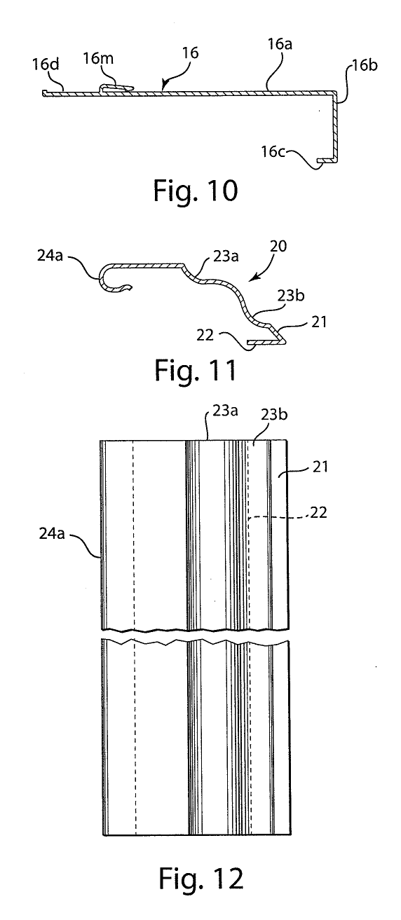

In the embodiment of FIG. 10, the casing face 16 is similar in overall construction to the previously described casing face but is provided with an extruded or otherwise similarly formed slot 16m in its upper surface to engage and lock an outwardly directed flange 22 of the casing molding, shown in FIGS. 2 and 3 in a manner previously and hereafter described.

FIGS. 11 & 12 show a somewhat enlarged view of the casing molding illustrated in FIGS. 2 & 3. In this configuration, the loop 24a may be bulbous as initially formed and shown in FIG. 2 to provide an interengagement with a corresponding shaped end of a J-channel. This loop 24a may be flattened as shown in FIG. 3 if the extruded material forming the casing mold is malleable. The corresponding flange 22 engages the slot in the casing face as previously described. The combination of the bulbous end 24a and flange 22 provide a double snap engaging means for engaging the J-channel on the left as shown in FIG. 2 and the casing face at the inner end of the interlock of the flange 22 with the slot (also as shown in FIG. 2).

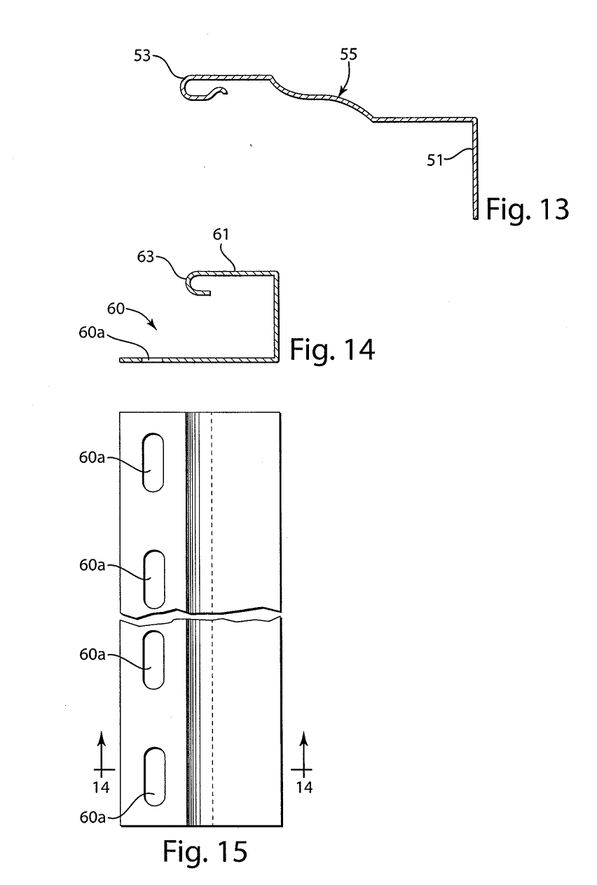

FIG. 13 illustrates a combined or integrated casing face and molding design specifically for, what is characterized in the trade as, “brick molding” or similar trim configurations on the outside of the building. In this configuration, the portion of the unit forming the casing molding 55 is integrally formed with casing face 51, which trim is shaped to fit over the inner side of the brick mold or other substitute wall covering and is secured thereto by nails or the like. The casing mould is terminated at its other end in a flange having a loop 53 which may have a constricted opening to receive and grip the edge of a J-channel shown in FIG. 14 more securely. One edge of the casing molding 55 may be integral with the casing face 51. The other edge may be snap-locked to a J-channel with the corresponding loop 53. In a manner similar to the arrangement of FIGS. 2 and 3.

FIGS. 14 & 15 show a J-channel in which a flange 61 of the J-channel 60 terminates at its free end in a curved loop 63 which may be interlocked with the loop 53 shown in FIG. 13 or similar loops. Similar to the other embodiments siding extends into the J-channel as described in the other embodiments. The j-channel may be provided with holes 60a sized to allow the j-channel to be nailed to the casing.

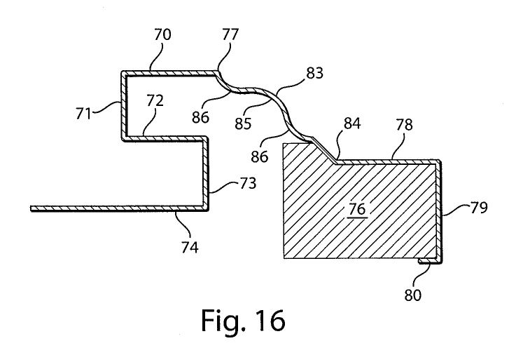

FIG. 16 illustrates a still further embodiment of a modified shape for the casing molding primarily designed as a new construction “brick mold” casing molding. Here, the outwardly extending flange 70 terminates in an S-shaped segment having legs 71, 72, 73, and 74. A J-shaped channel may be secured abutting legs 73 and between legs 72 and 74. Since this design is intended primarily for new construction, the use of a J-channel may not be necessary. In this construction, the edge of the siding simply extends between legs 72 and 74.

The construction of FIG. 16 is arranged with the outwardly extending flange 70 having its inner end spaced above and laterally from the casing engaging members 78 and 79. Casing engaging members 78 and 79 are orthogonally related planar members that are shaped to engage the wood casing of the window frame with flange 79 having an outwardly extending lip 80 adapted to engage the underside of the casing 76. In some installations extending lip 80 may be turned and the casing molding secured by nails. An inclined flange 83 interconnects the outer end 77 of flange 70 and the inner end 84 of flange 78. The inclined flange 83 as shown in the cross-section of FIG. 16 is undulating or forms reverse curves with convex and concave portions 85 and 86, respectively. These are continuous with one another as illustrated to form a non-linear surface between the adjacent edges of flange 70 and 78. The effect of this inclined flange 83 in the assembled unit is to provide a shadow-like feature when the assembled unit is installed and sunlight impinges on it.

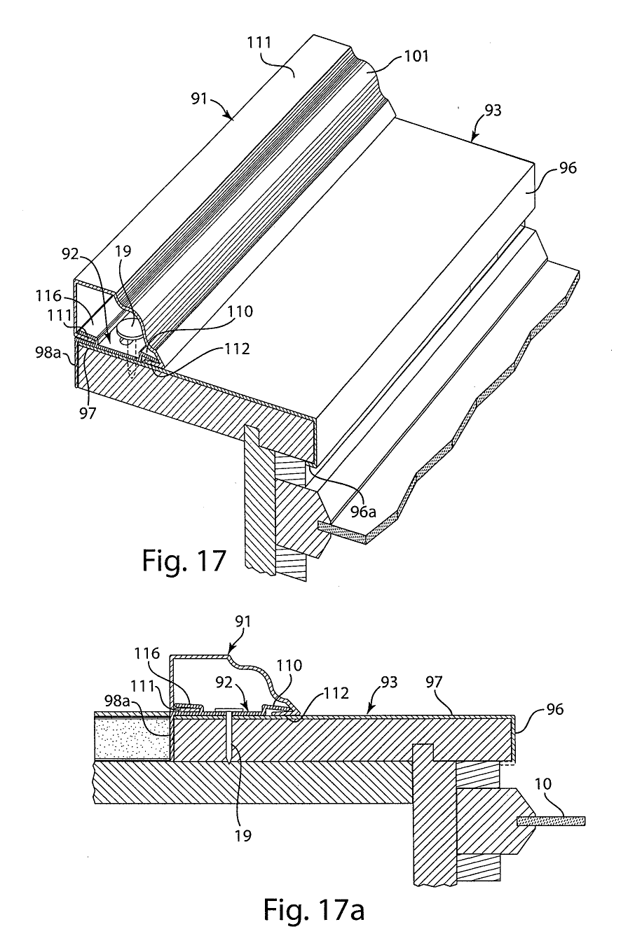

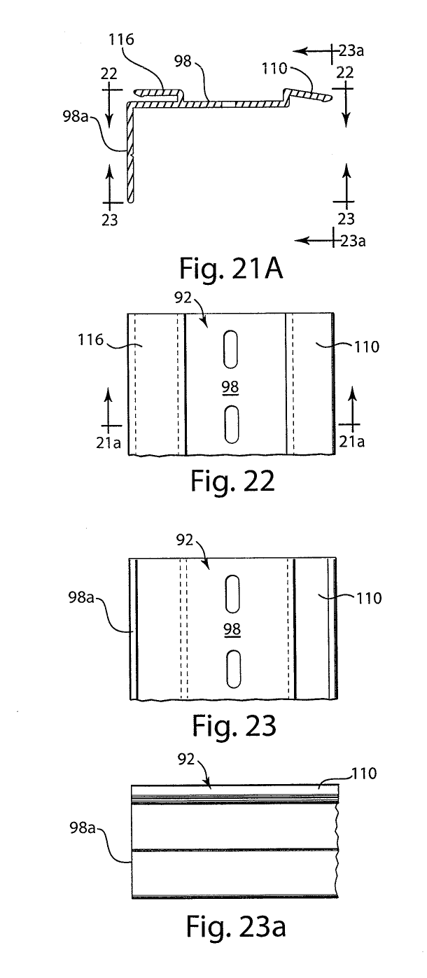

Turning now to the embodiments shown in FIGS. 17 and 17a there is illustrated a trim assembly designed as a stand-alone casing molding. In this configuration, a casing molding 91 is positioned above and engages a molding adapter or fastening strip 92 (see also FIGS. 21-23) which in turn is positioned over and in facing relation to the casing facing 93 and is secured thereto by suitable means such as nails in holes in the strip 92. The casing facing 93 is conventionally shaped to cover the casing and is formed with orthogonally related flanges 96 and 97 shaped and sized and positioned to engage the outer surfaces of the casing. The facing 93 may be suitably secured to the inner edge of the casing by a downwardly or orthogonally related flange 96 having an outwardly extending lip 96a adapted to engage the underside of the casing. The legs of flange 96 extend underneath the casing molding 91 and support the lower surface of the fastening strip 92. The inner end of the casing molding 91 is provided with an outwardly extending flange 112 positioned under the fastening strip 92. An inwardly extending flange 111 forming an integral part of the casing molding 91 is inter engaged with an offset flange 116 integral with the fastening strip 92 and forming a pocket into which flange 111 fits and is engaged. Inclined flange 101 is formed with reversed curves previously described in conjunction with similar constructions. These reverse curves provide the same function as those described earlier.

The fastening strip 92 shown in FIGS. 21a to 23a is used in the arrangement of FIG. 17. It is provided with orthogonally related flanges 98 and 98a with flange 98a extending downwardly on the outer surface of the casing and is suitably engaged to it by suitable means. The orthogonally related flange 98 extends inwardly and is formed at its inner end with an off-set barb 110 shaped to engage a portion of the casing molding 91 as shown in FIG. 17.

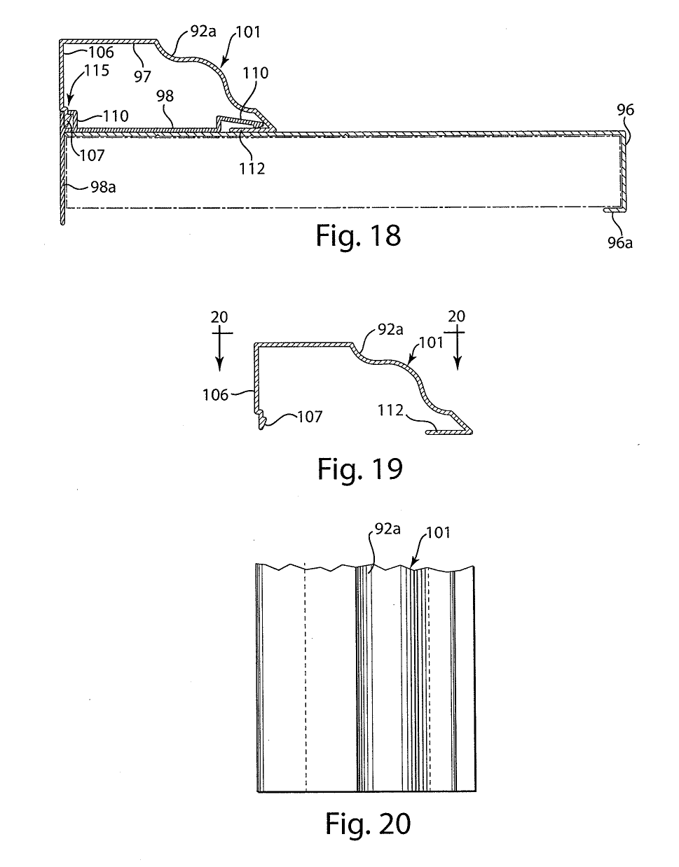

In the modification shown in FIG. 18, the flange 101 is flat at its outer end which in turn is integrally connected to an orthogonally related flange 106 which extends downwardly. The downwardly extending flange 106 terminates in a barb 107 which interengages a slot 110 formed in the fastening strip 92a at its inner end. The barb 107 interlocks with a projecting detent 115 integrally formed in a slot 110 extending upwardly from the flange 98.

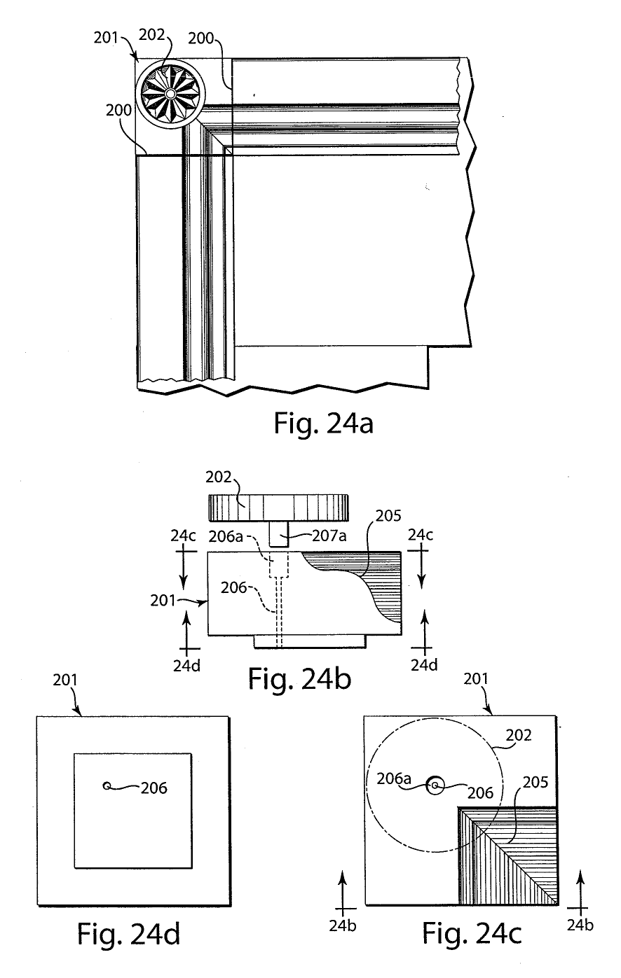

In FIGS. 24a-24c, there is illustrated a corner of an assembled unit in which the trim components are at a squared end 200. In this arrangement, a corner block 201 having a decorative feature such as a rosette 202 is secured. The corner block replaces the mitred corners of abutting trim members and typically may comprise a rectangle or square block having a surface segment 205 contoured to and complementary with the casing molding forming this particular trim assembly. The molding may be provided with a nail hole 206, coaxial hole 206a to receive a plug 207a supporting the rosette 202 which extends downwardly into and secured to the underlying components.

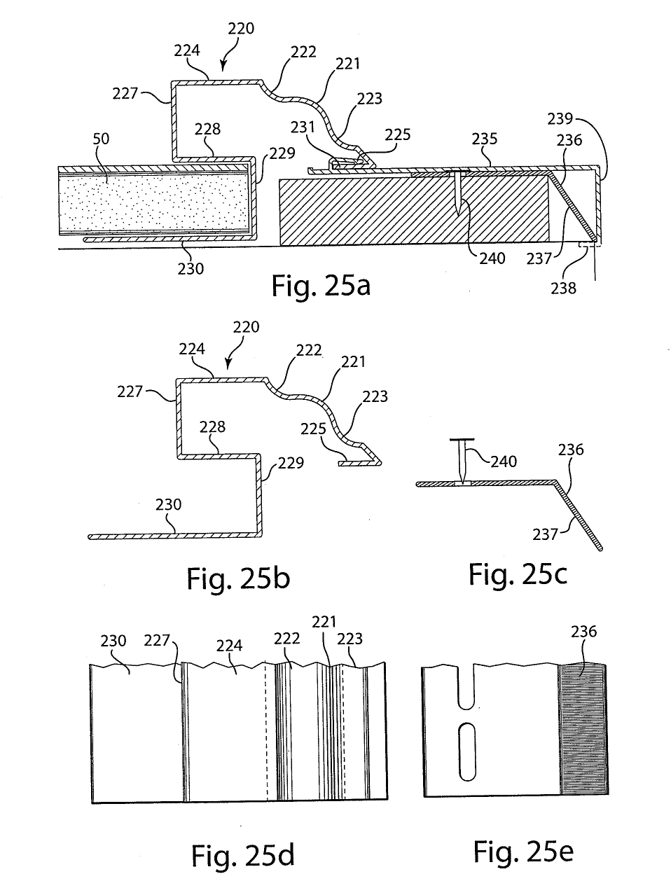

FIG. 25a illustrates a cross-sectional embodiment of trim components useful for new colonial style construction. It is not designed as a stand-alone. The casing molding, generally shown at 220, is provided with a web 221 having a pair of channels 222 and 223 defining a reverse curve that functions similarly to the channels 23a and 23b. Outwardly extending flange 224 is integrally connected with the outer end of the web 220 while an outwardly extending flange 225 is integral with the inner side of the web 221. The flanges 224 and 225 both extend outwardly and preferably are parallel to one another but are spaced laterally apart from one another. The flange 224 is integral with a downwardly extending flange 227, continuous with an inwardly extending flange 228, another downwardly extending flange 229, and an orthogonally outwardly extending flange 230 forming essentially an S-shape configuration style on the outer edge of the casing molding to receive siding or the like 50. The inner end of the casing molding 220 is secured by an interlock of the flanges 228, 229, and 230 with the siding material 50, while the inner edge of the casing molding 220 is connected to the flange 225 which extends outwardly and into interengagement with a slot 231. Slot 231 is integrally formed with the casing face 235 at the inner end and defines the slot 231 into which the flange 225 fits and is secured. A nailing clip 236 fits between the casing and the casing flashing 235 with the clip 236 having a downwardly extending flange 237 interengaging an inwardly extending lip 238 that is integral with the inner, downwardly extending flange 239 on the inner end of the casing face 235. The insert 236 interengages the outwardly extending flange 238 with the chip 236 which is secured to the casing by a nail 240 or by other suitable means.

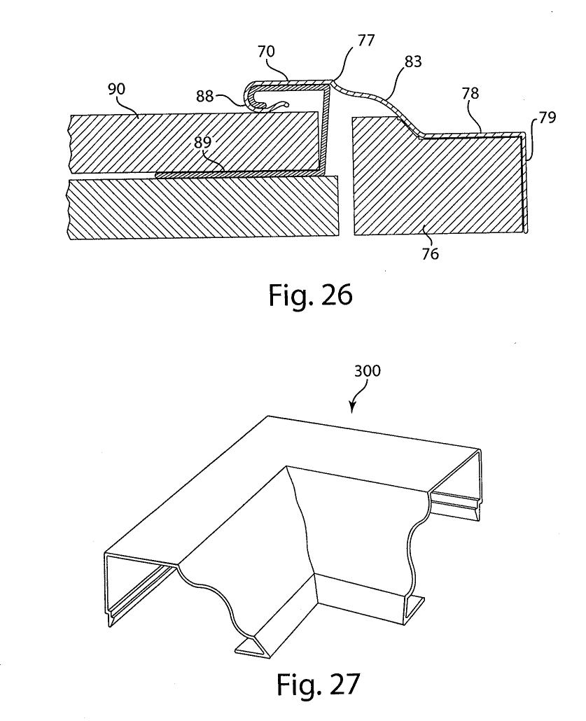

The embodiment of FIG. 26 is designed as a “brick molding” suitable specifically for a retro-fit into an existing structure.

FIG. 26 is a modification of the present invention designed primarily as a retro-fit construction for existing structures and is adapted particularly for brick mold casing installation. In this configuration, the construction is similar in design to the construction illustrated in FIG. 16 with like numbers corresponding. In this construction, however, the inclined flange 83 may be simplified with shallower concave and convex portions. The inner end of flange 70 terminates in a loop 88 shaped to receive a correspondingly shaped end of a J-channel 89 which may be used to support existing or previously installed siding 90. The loop 88 and the curved end of the J-shaped channel are sized and shaped to snap together to allow a quick interengagement of the two components when assembling the trim.

FIG. 27 illustrates a configuration of a corner block designed for use in a trim kit in preferably at least two or four of the corners of the installation. In this configuration, the casing molding is shaped as illustrated, with a cross-sectional configuration similar to the embodiments previously shown and, in particular to the embodiment in FIG. 18. The corner block shown in FIG. 26 may be dimensioned exactly the same as the ends of the casing molding shown in FIG. 18 so that the trim assembly may be arranged with a corner block 300 abutting the ends of adjacent, orthogonally related casing moldings. Alternatively, the molding may be formed with dimensions slightly larger or smaller to permit telescoping of the ends into engagement with the open ends of the corner block shown in FIG. 27. In this arrangement, the trim assembly need not have mitered corners in the casing molding when assembling the original unit.

The casing faces, casing moldings and J-channels may each be made for a trim kit package adapted for on-site fabrication. In this arrangement, these components, whether separately or integrally extruded, may be formed as extruded plastic or bent metal components having lengths, such as 20′ that will exceed the dimensions of the fenestration. On site they are cut to fit the particular installation using well-known techniques for installing window components.

As used in this specification the terms inward or inwardly, unless otherwise expressly stated, is related to the position of the fenestration or window. References to a direction parallel, or essentially parallel, refer to the major surface of the construction wall or the fenestration.

While aspects of the invention have been described with reference to various illustrative embodiments, such aspects are not limited to the embodiments described. Thus, it is evident that many alternatives, modifications, and variations of the embodiments described will be apparent to those skilled in the art. Accordingly, embodiments as set forth herein are intended to be illustrative, not limiting. Various changes may be made without departing from the spirit of aspects of the invention.

What is claimed is:

1. An extrusion for use in a frame assembly for a fenestration opening defined by a casing, a casing molding with a cross-section defined by a web intermediate and integrally connected to proximate sides of two parallel, but non-coplanar flanges, said intermediate web having a contoured surface, a flange orthogonally extending from the distal sides of one of the flanges and a barb at the free end of the orthogonally related flange shape to be engaged to secure the casing molding.

2. A casing molding as set forth in claim 1 wherein one of the two flanges extends outwardly from the edge of the web.

3. An extrusion as set forth in claim 1 having a fastening strip with spaced engaging members positioned to interengage and secure one of the non-coplanar flanges to the casing.

4. An extrusion as set forth in claim 3 having a casing facing covering at least a portion of the casing with the fastening strip secured to the casing facing.

5. An extrusion for use in a frame assembly for a fenestration opening defined by a casing, said extrusion comprising a casing molding with a cross-section defined by a web intermediate and integrally connected to proximate sides of two parallel but non-coplanar flanges, said intermediate web having a contoured surface, an orthogonally related flange extending from the distal side of one of the flanges and a barb shaped to be engaged at the free end of the orthogonally related flanges.

6. An extrusion for use in a frame assembly for a fenestration opening defined by a casing, said extrusion including a casing molding with a cross-section defined by a web intermediate and integrally connected to proximate sides of two, non-coplanar flanges, another flange extending from the distal edge of one of the two flanges and orthogonally related to the other of said two flanges, and means for securing the orthogonally related flange and the other of the two flanges to the casing.

7. An extrusion as set forth in claim 6, and a fastening strip secured to the casing and engaging the orthogonally related flange and the other of the two flanges.

8. An extrusion as set forth in claim 7 with a casing facing overlying and secured to the casing and to which the fastening strip is secured.

9. A frame assembly as set forth in claim 7 wherein the fastening strip has a barb shaped and sized to engage the one of said non-coplanar flange.

10. A frame assembly as set forth in claim 5 having a fastening strip intermediate the casing molding and casing and having means for engaging the casing molding including a barb engaging member.

11. A frame assembly as set forth in claim 10 wherein said barb engaging member includes a slot integral with and formed on the fastening strip into which the barb projects.

12. A corner block for engaging the casing members as defined in claim 5 having a pair of orthogonally related sections shaped to conform with and engage ends of a pair of orthogonally related casing moldings.

13. A corner block as set forth in claim 12 wherein the ends of the casing molding slideably interengage ends of the corner block.
